(19) United States
(12) Patent Application Publication
(10) Pub. No.: US 2018/0050407 A1
(43) Pub. Date: Feb. 22, 2018

(54) MAGNETIC SOLDERING APPARATUS

(71) Applicant: Mark Richards, Charleston, SC (US)

(72) Inventor: Mark Richards, Charleston, SC (US)

(21) Appl. No.: 15/240,687

(22) Filed: Aug. 18, 2016

(51) Int. Cl. B23K 3/08; B23K 1/00

(52) U.S. Cl. CPC B23K 3/087; B23K 2201/42; B23K 1/0016

(57) ABSTRACT

A soldering attachment apparatus having bendable magnetic arms and a substantially planar metal base. The base is constructed of a ferrous metal and the arms are comprised of flexible steel gooseneck having a bottom portion with a magnet, and a top portion having an alligator clip or other accessory. The arms are magnetically coupled to the base via the magnet. The arms can be of varying length and are easily removed or slid across the metal base for unlimited repositioning. This repositioning allows the user to angle an object for optimum soldering. The soldering tool can be used to hold circuit boards, jewelry, 3D printed parts and a variety of other objects when soldering.

### FIELD

The present disclosure relates to the field of mechanical tools; in particular, an apparatus for holding objects for soldering.

### BACKGROUND

Soldering is a process in which two or more items (usually metal) are joined together by melting and putting a filler metal (solder) into the joint, the filler metal having a lower melting point than the adjoining metal. Soldering differs from welding in that soldering does not involve melting the work pieces. Soldering can be a very delicate and difficult process. The person applying the solder must hold the substrates steady and together in order to apply the solder. Maintaining the substrates in a steady position while soldering is imperative to administering the correct amount of solder in the correct location. Applications such as printed circuit board soldering require positioning the board at certain angles in order to apply the solder accurately.

Various prior art solutions exist to assist with securing an object in a stationary location for soldering. Prior art solutions consist of vices, clamps, adhesives and the like. For optimal soldering, a device must hold the object to be soldered in place, yet enable a range of motion for positioning the object at various angles and positions according to the required placement of the solder on that object. While prior art solutions are effective in securing an object for soldering in a stationary position, these solutions fail to provide for a truly multi-positioned soldering tool.

Through applied effort, ingenuity, and innovation, Applicant has identified a number of deficiencies and problems with soldering devices. Applicant has developed a solution that is embodied by the present invention, which is described in detail below.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is a gooseneck flexible steel arm that can easily be manipulated into a position to attach and hold various substrates. These flexible arms will maintain their position until configured differently.

An object of the present disclosure is a gooseneck flexible steel arm with a magnetic bottom that can be slideably positioned on a base.

An embodiment of the present disclosure is a soldering apparatus comprising a base constructed of a ferrous metal, the base being substantially planar in shape and having a magnet-receiving surface; and a plurality of arms magnetically coupled to the magnet-receiving surface, each arm in the plurality of arms having a base portion containing a magnet, a bendable arm portion, and an attachment portion.

A specific embodiment of the present disclosure includes a soldering apparatus comprising a base constructed of a ferrous metal, the base being substantially planar in shape and having a magnet-receiving surface; a first set of arms having a base portion containing a magnet, a bendable arm portion, and an attachment portion; and a second set of arms having a base portion containing a magnet, a bendable arm portion, and an attachment portion.

A specific embodiment of the present disclosure includes a soldering apparatus comprising a base constructed of a ferrous metal, the base being substantially planar in shape and having a magnet-receiving surface; and at least one arm having a base portion containing a magnet, a bendable arm portion, and an attachment portion.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is a perspective view of the soldering attachment apparatus, according to an embodiment of the present disclosure;

FIG. 2 is a perspective view of a base of the soldering attachment apparatus, according to an embodiment of the present disclosure;

FIG. 3 is a partial bottom view of a slip-resistant material coupled to a bottom surface of the base of the soldering attachment apparatus, according to an embodiment of the present disclosure.

FIG. 4 is a perspective view of flexible arms of the soldering attachment apparatus, according to an embodiment of the present disclosure.

FIG. 5 is a perspective in-use view of a soldering attachment apparatus, according to an embodiment of the present disclosure.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

Embodiments of the present disclosure provide for a soldering tool. Embodiments of the present disclosure solve problems associated with prior art soldering devices that hold substrates in a manner that is inflexible and/or not optimal for precision soldering. The prior art is generally made up of devices that utilize a vice to hold the soldering substrate. These devices are inflexible and do not provide an adequate range of motion for repositioning the substrate at various angles. Embodiments of the present disclosure seek to overcome the deficiencies in the prior art, and provide a more flexible and varyingly adjustable holding device for soldering.

According to various embodiments of the present disclosure, the problem of limited adjustability with attachment devices for soldering is solved by utilizing a flexible steel arm. The steel arm is capable of bearing weight while maintaining a flexible range of motion. The flexible arms have an attached alligator clip at the proximal tip used to hold the substrate in position. Soldering requires that the substrates be held in a stationary position as the solder is applied. The strong flexible arms are capable of holding the substrate immobile while allowing the user to conveniently reposition the substrate for optimal soldering.

According to various embodiments of the present disclosure, the problem of limited adjustability with attachment devices for soldering is further solved by a magnet in the base of the flexible arm coupled to a planar metal base. The magnet is attracted to the ferrous metal of the soldering tool base. This attraction allows the flexible arms to be moved and repositioned at any point on the surface of base. The movable flexible arms allow the user to position the substrate at various angles providing better accuracy and optimal soldering position.

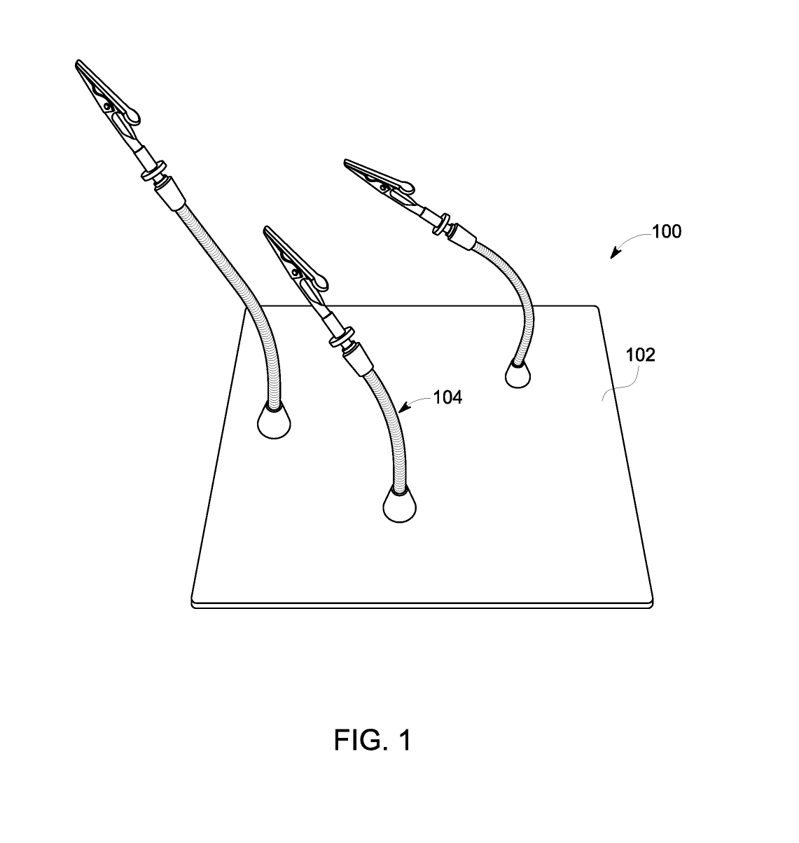

Referring now to FIG. 1, a perspective view of the soldering attachment apparatus 100 is shown. According to an embodiment, soldering attachment apparatus 100 is generally comprised of a base 102 and arms 104. The base 102 is made of a ferrous metal and is substantially planar in shape. The base 102 may have a powder coating. The base 102 has a smooth metal surface that allows the arms 104 to be slid across the surface and repositioned at any location on the surface of the base 102. This means of magnetic attachment enables almost unlimited configurations of the arms 104 on the surface of base 102, thereby enabling the user to configure arms 104 in a desired position according to the size, shape, and weight of the object or substrate to be soldered. The base 102 is weighted in order to keep the arms and substrate from tipping. The arms 104 are comprised of a flexible steel gooseneck attached to a conical-shaped base that contains a magnet. The magnet attaches the arms 104 to the metal base 102 through a magnetic attraction. The arms 104 also contain an alligator clip attached to the top portion of the gooseneck. The alligator clip allows the arms 104 to hold in place the substrate being soldered. The magnet, alligator clip, and flexible gooseneck are the elements that enable arms 104 to hold and reposition a substrate at varying angles on the base 102 for optimal soldering.

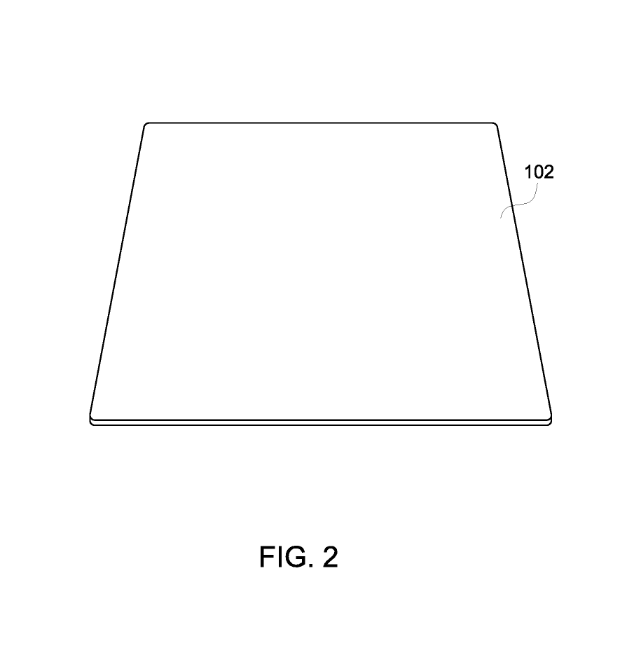

Referring now to FIG. 2, a perspective view of base 102 is shown. Base 102 is constructed of ferrous metal and has a powder coating. The metal base 102 attracts magnets in the arms 104 and creates a stabilizing magnetic force. Metal base 102 functions to stabilize soldering attachment apparatus 100 during use, and functions to provide a surface upon which arms 104 may be magnetically coupled. The ferrous metal allows the entire top surface of base 102 to receive a magnet. This feature provides for unencumbered positioning of the arms 104 over the entire surface of base 102. In addition, the surface of base 102 allows the user to position arms 104 in any location to hold the substrate in an optimal soldering angle and utilize as many arms 104 as needed.

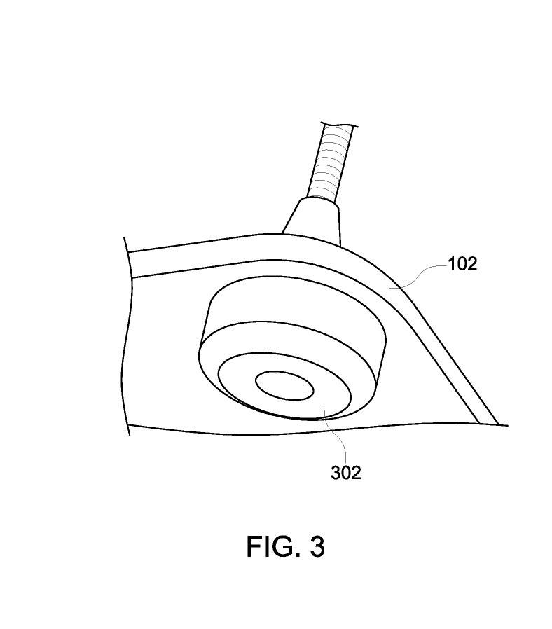

Referring now to FIG. 3, a partial bottom view of soldering attachment apparatus 100 is shown. As described in FIG. 1, soldering attachment apparatus 100 is generally comprised of a base 102 and arms 104. According to an embodiment, soldering attachment apparatus 100 may further comprise slip-resistant material 302. The slip resistant material may be rubber, silicone, adhesive, plastic, and the like. FIG. 3 demonstrates slip-resistant material 302 coupled to a bottom surface of base 102. Slip-resistant material 302 is in the form of a short footing. Slip-resistant material 302 may be alternatively constructed in a thin layer and disposed upon the bottom of the soldering tool base 102. Slip-resistant material 302 secures base 102 from sliding and allows the arms 104 (as shown in FIG. 1) to hold the substrate in a steady position while soldering.

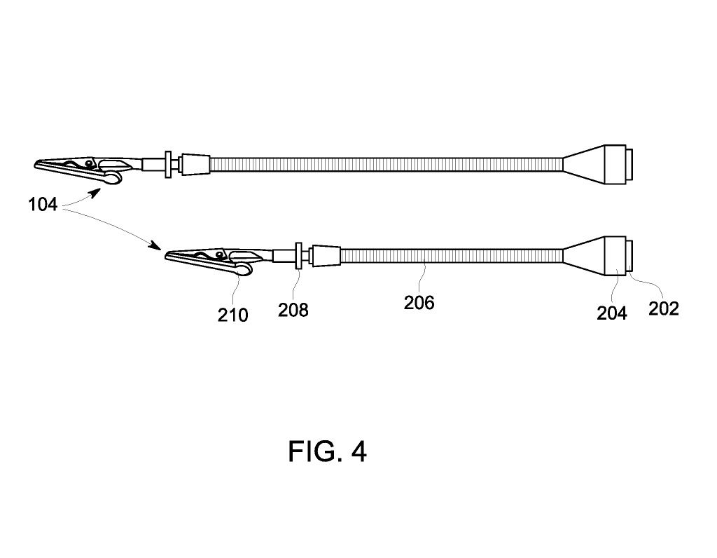

Referring now to FIG. 4, a perspective view of a base 102 and arms 104 as shown. Arms 104 are generally comprised of a magnet 202 coupled to a base portion 204, a gooseneck bendable arm portion 206, an attachment portion 208, and a clip 210. Base portion 204 may be conical or cylindrical in shape, or may be comprised only of a magnet. According to an embodiment, clip 210 may be removed from the attachment portion 208 and interchanged with a different mechanism such as a soldering iron holder, clamp, light, vice, magnet, magnifying glass and various other instruments. The gooseneck bendable arm portion 206 may be constructed of flexible steel, or other bendable material such as metal or plastic wire. Base portion 204 is shaped in a cone configuration in order to provide stability to the arm in an upright position. The cone configuration aids in distributing the weight of the substrate being held and prevents tipping. Base portion 204 may be alternately configured in different geometric shape capable of providing stability. A magnet 202 is coupled to the bottom of base portion 204 to create a stabilizing magnetic force between the arms 104 and the base 102. This magnetic force along with the flexible steel allow arms 104 to suspend a substrate above the base. FIG. 4 demonstrates how arms 104 can slide or be removed from the magnet-receiving surface and repositioned anywhere on base 102, enabling substantially unlimited configurations of arms 104 by the user. FIG. 4 also illustrates arms 104 of different lengths. According to a specific embodiment, arms 104 can be made up of a first set of arms with gooseneck bendable arm portion 206 of 300 mm in length and a second set of arms with gooseneck bendable arm portion 206 at 100 mm in length. According to an embodiment of the present disclosure, the length of gooseneck bendable arm portion 206 of a first set of arms may be in the range of about 20% to about 300% longer in length than the second set of arms 104. The varying lengths of the arms 104 allow the user to increase the angle at which the substrate is held to more vertical positions. The strength of the gooseneck bendable arm portion 206 varies with the varying length. According to an embodiment of the present disclosure, arms 104 with a longer gooseneck bendable arm portion 206 may be in the range of about 10% to about 100% stronger than arms 104 of shorter gooseneck bendable arm portion 206.

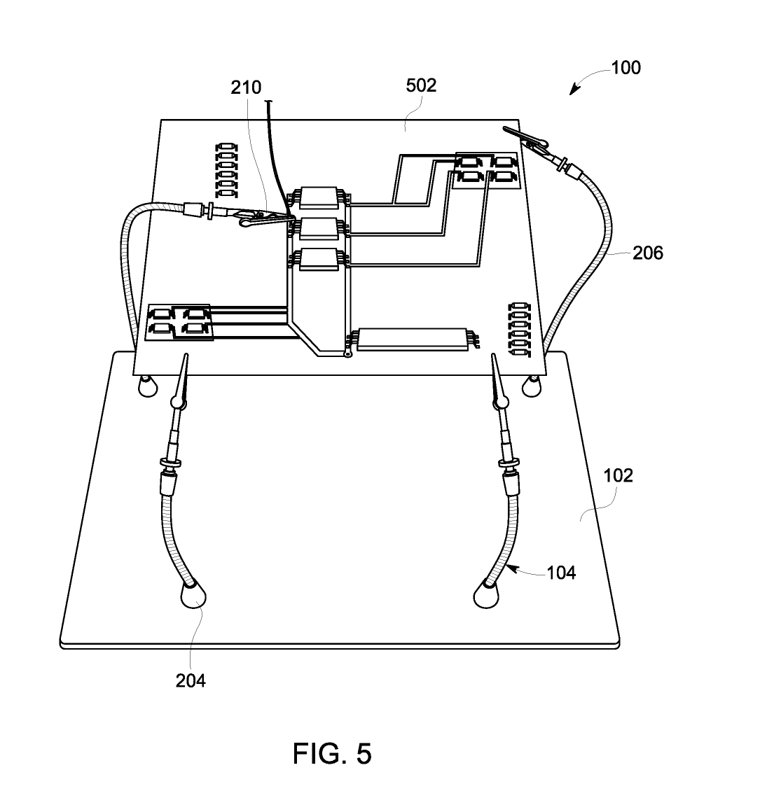

Referring now to FIG. 5, a perspective in-use view of soldering attachment apparatus 100 showing arms 104 in varying lengths. According to an embodiment, FIG. 5 depicts two sets of arms 104, each of a different length. FIG. 5 demonstrates the flexibility of the arms 104 in holding a substrate such as a circuit board 502. The arms 104 can be moved along the surface of the base 102 and repositioned as desired by the user to hold the circuit board 502 at varying angles. In addition, soldering attachment apparatus 100 can be used when soldering jewelry, stained glass, 3D printed objects and various other crafts and repairs. It should be readily understood the various modifications can be made to the invention without departing from the spirit thereof. For instance, while FIG. 5 illustrates a specific embodiment, it should be understood that the base 102 and the arms 104 could be modified in area, shape, weight, and strength to accommodate a range in the size of the substrate being held. Further, while one embodiment depicts a clip 210 on the end of the arms 104, the attachment portion 208 (as depicted in FIG. 4) is designed to accommodate the clip being interchanged with a variety of instruments such as a vice, soldering iron holder, light, magnifying glass, pipe clamp, or magnet.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention.

What is claimed is:

1. A soldering apparatus comprising:
a base constructed of a ferrous metal, the base being substantially planar in shape and having a magnet-receiving surface, and a powder coating disposed upon the magnet receiving surface of the base; and
a plurality of arms magnetically coupled to the magnet-receiving surface, each arm in the plurality of arms having a base portion containing a magnet, a bendable arm portion, and an attachment portion, the base portion being shaped in a cone configuration such that a weight load at the attachment portion is distributed at the base portion.

2. The apparatus of claim 1 wherein the attachment portion is interchangeable.

3. The apparatus of claim 1 wherein the attachment further comprises an attachment selected from the group consisting of a clamp, an alligator clip, a light, and a magnifying glass, a soldering iron holder, a magnet, a vice or a combination thereof.

4. The apparatus of claim 1 wherein the plurality of arms may be slideably positioned to a desired configuration on the magnetic receiving surface.

5. The apparatus of claim 1 further comprising at least four feet coupled to a bottom surface of the base, the at least four feet being configured to stabilize the base.

6. The apparatus of claim 1 wherein the bendable arm portion is constructed of flexible steel.

7. The apparatus of claim 1 wherein the number of arms in the plurality of arms is selectively variable.

8. A soldering apparatus comprising:
a base constructed of a ferrous metal, the base being substantially planar in shape and having a magnet-receiving surface, and a powder coating disposed upon the magnet receiving surface of the base;
a first set of arms having a base portion containing a magnet, a bendable arm portion, and an attachment portion; and
a second set of arms having a base portion containing a magnet, a bendable arm portion, and an attachment portion, the base portion being shaped in a cone configuration such that a weight load at the attachment portion is distributed at the base portion.

9. The apparatus of claim 8 further comprising a slip-resistant material coupled to a bottom surface of the base.

10. The apparatus of claim 8 wherein the attachment further comprises an attachment selected from the group consisting of a clamp, an alligator clip, a light, and a magnifying glass, a soldering iron holder, a magnet, a vice or a combination thereof.

11. The apparatus of claim 8 wherein the first set of arms and the second set of arms may be slideably positioned to a desired configuration on the magnetic-receiving surface.

12. The apparatus of claim 8 wherein the length of the bendable arm portion of the first set of arms is in the range of 20% to 300% longer than the length of the bendable arm portion of the second set of arms.

13. The apparatus of claim 8 wherein the strength of the bendable arm portion of the first set of arms is in the range of 10% to 100% stronger than the strength of the bendable arm portion of the second set of arms.

14. The apparatus of claim 8 comprising one or more additional sets of arms.

15. A soldering apparatus comprising:
a base constructed of a ferrous metal, the base being substantially planar in shape and having a magnet-receiving surface, and a powder coating disposed upon the magnet receiving surface of the base; and,
at least one arm having a base portion containing a magnet, a bendable arm portion, and an attachment portion, the base portion being shaped in a cone configuration such that a weight load at the attachment portion is distributed at the base portion.

16. The apparatus of claim 15 wherein the bendable arm portion of the at least one arm is variable in length.

17. The apparatus of claim 15 wherein the at least one arm may be slideably configured to a desired position on the magnetic-receiving surface.

18. The apparatus of claim 15 wherein the attachment portion is interchangeable.

19. The apparatus of claim 15 further comprising a slip-resistant material coupled to a bottom surface of the base.

20. The apparatus of claim 15 wherein the magnet-receiving surface comprises the entire area of the base.
